(19) United States
(12) Patent Application Publication
(10) Pub. No.: US 2013/0065467 A1
(43) Pub. Date: Mar. 14, 2013

(54) Substrate Printed with a Water-Based Urethane Printing Ink with Improved Performance Properties

(71) Applicants: Faye Transvalidou, East Rutherford, NJ (US); Huanyu Wei, Fair Lawn, NJ (US); Alexander Chudolij, Clifton, NJ (US); Leda Mora, Little Ferry, NJ (US)

(72) Inventors: Faye Transvalidou, East Rutherford, NJ (US); Huanyu Wei, Fair Lawn, NJ (US); Alexander Chudolij, Clifton, NJ (US); Leda Mora, Little Ferry, NJ (US)

(73) Assignee: SUN CHEMICAL CORPORATION, Parsippany, NJ (US)

(21) Appl. No.: 13/229,699

(22) Filed: Sep. 10, 2011

(51) Int. Cl. B32B 27/02; B05D 5/00; B32B 27/08; B32B 27/32; B32B 27/30; B32B 27/34

(52) U.S. Cl. 442/166; 442/59; 442/170; 442/168; 428/500; 427/256

(57) ABSTRACT

A substrate has a surface printed with an ink or coating composition with excellent adhesion and dry rub resistance, and very good oil and saline rub resistance (crock) properties using a multi-functional carbodiimide as a crosslinker for nonwoven substrates. The rub performance of the ink or coating printed on a nonwoven substrate has been found to be superior to that of a first Sun benchmark ink including pigments for four color printing. In another embodiment, a carbodiimide crosslinker such as multifunctional Carbodilite SV-02 is added to the compositions to further improve rub resistance (crock) and retain liquid characteristics post inoculation when compared to compositions using aziridine as a crosslinker. In a further embodiment, a thin polyolefin film exemplifying a backsheet of a hygiene product was printed with the same crosslinked ink or coating composition and compared with a second Sun benchmark set of inks.

### CROSS-REFERENCE

This application is a national stage entry application from PCT U.S. Ser. No. 10/29406 filed Mar. 31, 2010 which claims priority to U.S. Provisional Patent Application Ser. No. 61/164,941, filed Mar. 31, 2009, and further claims priority to U.S. Provisional Patent Application Ser. No. 61/383,052, filed Sep. 15, 2010, the entire disclosures of which are hereby incorporated by reference into the present application.

### TECHNICAL FIELD

Aspects described herein relate to the field of printing on polymeric substrates, especially those of low polarity or non-polar substrates (for example, polyolefins, polyamides, polyesters, polylactic acid (PLA) and its derivatives, copolymers, polyvinylchloride and so on). Such substrates typically exhibit low surface energy and consequently poor wetting and adhesion of inks and coatings. More specifically exemplary substrates and articles of manufacture relate to films, breathable films, and highly porous substrates printed or coated with water based coatings and printing inks. The substrates used for printing with such inks or coatings may, for example, be made of polymeric fibers such as nonwoven mats and films that are used in layered structures for hygiene products (diapers, training pants, incontinence products), feminine care, garments (industrial work wear, lab coats, pants, aprons, coveralls); household items and food service items such as cleaning wipes; infection control articles such as those used in hospitals (curtains, single use clothing items such as gowns and “scrubs,” bed underpads, convenience covers and pouches for various devices used in patient care, bandages and wound care items, sterilization pouches); geotextiles (landscaping and road construction materials); house construction materials and wall coverings; furniture (upholstery and furniture components, window shades), filters used in home appliances and in industrial applications, convenience articles such as reusable shopping bags; outdoor fabrics (covers for lawn furniture, awnings, canopies, tents, and the like); marine and automobile fabric and felt (for use in boats and automobile interiors); and many other convenience applications.

### DISCUSSION OF RELATED ART

Printing on substrates with water based inks is well known in the art. The related technical arts include United States patents and published applications which discuss the state of the art. In particular, a typical nonwoven article of manufacture for printing with such inks is a personal care product such as a diaper, training pants and hygiene products as discussed below.

U.S. Pat. No. 5,695,855, of R. S. Yeo, et al., entitled “Durable Adhesive-Based Ink-Printed Polyolefin Nonwovens” describes a substrate such as a personal care product which may be, for example, diapers, training pants, incontinence products, feminine products and the like. According to Yeo et al., a nonwoven web, printed with two main components of an adhesive-based ink and a polyolefin substrate, results in crock values of four or greater.

U.S. Pat. No. 5,853,859, of R. L. Levy et al., entitled “Room Temperature Latex Printing” describes a thermoplastic polyolefin substrate used in the food service industry such as a disposable wiper printed with a latex composition, a pigment and a cure promoter, retaining colorfastness when exposed to liquids of pH between two and thirteen. Testing using acid, saline and base solutions is known from such a disclosure for demonstrating colorfastness.

US2007/0100025 A1, of D. Steiner et al., entitled “Flexographic and Gravure Printing Inks for Nonwoven Substrates” describes a printing ink used on nonwoven substrates that contains polyurethane resin with a rub rating of six (appraisal scale of one for worst through ten for best), solvent and colorant. An intended product includes a diaper, training under pants and a temporary swimsuit.

US2008/0255275, of C. B. Williams et al., entitled “Printing Inks for Nonwoven Substrates” describes a printing ink used on nonwoven substrates that contains polyurethane resin with a rub rating of 6 (appraisal scale of 1 for worst-10 for best), solvent and colorant. The intended products include diapers, training under pants and swimsuits.

U.S. Pat. No. 5,458,590, of R. Schleinz et al., entitled “Ink-Printed, Low Basis Weight Nonwoven Fibrous Webs and Method” describes a method of making a laminated structure (web), printing it to create a web of high wet crockfastness value (greater than four) and creating absorbent articles comprising this web. The intended product is a personal care product, for example, diapers and training pants. Schleinz et al. describe a solvent based block urethane system that also comprises a vinyl resin, wax, and epoxidized soybean oil along with pigments, but the particular block urethane used may not be acceptable for a garment application (human contact).

WO 2008/060855, of D. Steiner et al., entitled “Water Based Printing Inks for Nonwoven Substrates,” describes a waterborne composition comprising a color transfer resistant combination of water based polyurethane resin, water and a colorant. Intended products include personal care products such as diapers, training pants, wipes, feminine pads, adult incontinence garments, clothing such as hospital gowns, work clothing and cleaning garments

US2008/0227356, of S. Poruthoor et al., entitled “Substrates Having Improved Ink Adhesion and Oil Crockfastness,” describes a nonwoven web printed with an ink comprising a crosslinking agent (more than 3.5% of the dried composition), where the crosslinking agent comprises an aziridine oligomer with increased functionality. An intended product is an exemplary training pant or diaper having an exploded cross-section shown in FIG. 2. The diaper of FIG. 2 includes a nonwoven web as an outward facing layer, a backsheet, an absorbent core and a top sheet. A spunbound web of polypropylene fibers is laminated to a polypropylene film to form a laminate and the laminate is tested for wet and oil crockfastness where the laminate was taken from a diaper sold under the name HUGGIES® Supreme available from Kimberly Clark, Inc. of Dallas, Tex. WO 02/051644A1 discloses a crosslinked coating for use on a nonwoven substrate wherein polyisocyanate is the hardener.

It is also known in the printing arts that, besides using aziridine, to use a crosslinking agent comprising carbodiimide chains.

U.S. Pat. No. 6,121,406, of Y. Imashiro, et al., entitled “Mixture of Hydrophilic Dicyclohexylmethanecarbodiimide,” is assigned to Nisshinbo Industries, Inc. of Tokyo, JP. Imashiro et al. describe a hydrophilic dicyclohexylmethanecarbodiimide represented by the formula (1): wherein n is an integer of 1 to 10 and R¹ is a residue of a mixture of organic compounds of different hydrophilicites each having at least one hydroxyl group capable of reacting with an isocyanate group. The hydrophilic dicyclohexylmethanecarbodiimide is allegedly improved in reactivity and storage stability and is thereby easy to handle as a crosslinking agent for hydrophilic resins.

U.S. Pat. No. 5,859,166, of E. Sasaki, et al., entitled “Hydrophilic Resin Composition,” is also assigned to Nisshinbo Industries. Sasaki et al. describe a hydrophilic resin composition obtained by adding a hydrophilic carbodiimide of a specified general formula to a hydrophilic resin selected from a carboxyl group-containing hydrophilic polyester resin and a carboxyl group-containing hydrophilic polyurethane resin, and a hydrophilic carbodiimide

U.S. Pat. No. 6,124,398, of Y. Imashiro, et al., entitled “Carbodiimide Crosslinking Agent, Process for Preparing the Same, and Coating Material Comprising the Same,” is also assigned to Nisshinbo Industries. Imashiro et al. describe a carbodiimide crosslinking agent comprising, as its main component, a decarbonated condensate of (A) one or more isocyanates selected from isocyanates having at least two isocyanate groups bonded to the carbon of the methylene group in the molecule, and (B) one or more isocyanates selected from alicyclic or aliphatic diisocyanates other than those defined in (A). The condensate is blocked at terminal isocyanates thereof with a hydrophilic group. A process for preparing the crosslinking agent and a coating material comprising the agent are also described, along with a specific type of crosslinking agent for polyvinyl alcohols.

U.S. Pat. No. 5,856,014, of Y. Imashiro, et al., entitled “Aqueous Coating Composition for the Manufacture of Precoated Metal,” is also assigned to Nisshinbo Industries. Imashiro et al. describe an aqueous coating composition for the manufacture of precoated metal based on an aqueous resin having a carboxyl group in a molecule and neutralizable with a basic material as a binder, the aqueous resin being selected from an acrylic copolymer resin, polyester resin, and polyurethane resin. A mono- or poly-carbodiimide compound is blended with the aqueous resin. The composition forms a coating having improved chemical resistance, water resistance and adhesion to sheet metal.

U.S. Pat. No. 6,127,029, of Y. Imashiro, et al., entitled “Reinforcing Material Surface-Treated with Aqueous Surface-Treating Agent, and Composite Material Comprising Said Reinforcing Material,” is also assigned to Nisshinbo Industries. Imashiro et al. describe an aqueous surface-treating agent and method for surface treatment of reinforcing material, which includes a carbodiimide compound as a main component; a reinforcing material surface-treated with the above aqueous surface-treating agent; and a composite material comprising a matrix and the above reinforcing material. The aqueous surface-treating agent allegedly has good storage stability, no adverse effect on human health owing to no use of organic solvent and, when used for the surface treatment of a reinforcing material, can produce a surface-treated reinforcing material. A composite material comprises a matrix and the surface-treated reinforcing material and has a high adhesivity between the two components. All of the Nisshinbo Industries U. S. patents discussed above relate to use in printing inks.

U.S. Pat. No. 5,929,188, and U.S. Pat. No. 6,211,293 of M. Nakamura et al., entitled “Polycarbodiimide Compound, Production Process Thereof, Resin Composition, and Treatment Method of Article,” describes a polyfunctional polycarbodiimide compound containing at least four molecular chains bonded independently to a backbone. Each of the molecular chains contains a carbodiimido (—N═C═N—) group. The polyfunctional carbodiimide compound can be produced by reacting (a) an isocyanate compound having at least one carbodiimido group and at least one isocyanate group with (b) a polyol, polyamine and/or amino alcohol having at least four hydroxyl, primary amino and/or secondary amino groups in a molecule. Also disclosed is a resin composition containing the polyfunctional carbodiimide compound as a crosslinking agent, and a treatment method of an article, which makes use of the resin composition. Non-toxicity and safety are identified as advantages. A product using a coating including such a crosslinking agent may be a woven fabric of synthetic fibers.

U.S. Pat. No. 5,258,481, of L. Hesselmans et al., entitled “Multifunctional Water-Dispersible Crosslinking Agents,” describes a further type of carbodiimide based cross-linking agent known as a multi-functional carbodiimide water-dispersible crosslinking agent. These crosslinking agents are products consisting of oligomeric compounds containing carbodiimide functions and other reactive functional groups. Further, Hesselmans et al. describe aqueous dispersions, emulsions or solutions with such crosslinking agents. In certain examples, Hesselmans et al suggest utilizing an aziridine ring as a reactive functional group.

Consequently, from the known printing arts, the utilization of aziridine as a crosslinking agent is known for printing such articles of manufacture as personal care products. Also, a known crosslinking agent known in the arts is a so-called multi-functional carbodiimide. Aziridine is known to provide high crockfastness values but demonstrates at least toxicity and safety issues. There remains a need in the arts to improve upon the crockfastness of a water-based composition, to demonstrate the existence of non-toxic coating components, for example, using carbodiimide as a crosslinking agent and to expand the articles of manufacture to incorporate a greater variety of products.

### SUMMARY OF EMBODIMENTS, ASPECTS THEREOF AND METHODS

This specification relates to the field of printing on polymeric substrates, specifically those of low polarity or non-polar substrates, more specifically, polypropylene and polyethylene that typically exhibit low surface energy and consequently poor wetting and adhesion of inks and coatings. More specifically, a water based urethane coating and printing ink optionally using a multifunctional carbodiimide as a crosslinking agent for highly porous polymeric substrates made of polymeric fibers such as nonwoven mats may be used in layered structures for printing a surface, coating, or impregnating a layer of an article of manufacture such as a hygiene product (diapers, training pants, incontinence products), feminine care product, garments (industrial workwear, lab coats, pants, aprons, coveralls and limited use swimsuits); household items, industrial cleaning and food service items such as cleaning wipes; infection control articles such as those used in hospitals (curtains, single use clothing items “scrubs”, bed underpads, convenience covers and pouches for various devices used in patient care, bandages and wound care items, sterilization pouches); geotextiles (landscaping and road construction materials); house construction materials and wall coverings; furniture (upholstery and furniture components, window shades), filters used in home appliances and in industrial applications, convenience articles such as reusable shopping bags; filters used in home appliances and in the automotive industry; outdoor fabrics (covers for lawn furniture, awnings, canopies, tents and the like); marine and car interior fabrics and felts (for use in boats and automobiles); and many other convenience applications.

As used herein, the term “nonwoven” refers to a sheet, web, or bat of natural and/or man-made fibers or filaments, excluding paper, that have not been converted into yarns, and that are bonded to each other by any of several means. The various methods for bonding include, but are not limited to: a) adding an adhesive; b) thermally fusing the fibers or filaments to each other or to the other meltable fibers or powders; c) fusing fibers by first dissolving, and then resolidifying their surfaces; d) creating physical tangles or tuft among the fibers; and/or e) stitching the fibers or filaments in place. Additionally, the term “nonwoven” may also refer to a manufactured sheet, web or bat of directionally or randomly oriented fibers, bonded by friction, and/or cohesion and/or adhesion, excluding paper or products which are woven, knitted, tufted stitch bonded incorporating binding yarns or filaments, or felted by wet milling, whether or not additionally needled. The fibers may be of natural or man-made origin. Materials that may be used in manufacturing nonwoven mats or webs or composites are polyolefins (for example, polyethylene, polypropylene and so on, polyamides (nylon), polyesters (for example, PET, PBT and other polyesters), polylactic acid (PLA) and its derivatives, acrylics, styrene-based polymers, halogenated hydrocarbon polymers, vinyls, copolymers, polyvinylchloride or proprietary mixture compositions such as those by Kraton Polymers of Houston, Tex. or those available by Kuraray Company, Ltd. of Okayama, Japan under the trade name SEPTON®. Nonwoven mats or webs may also consist of polymers of core-sheath type bicomponent fibers, or physical mixtures of different kinds of fibers. A more detailed discussion of such materials can be found in US2008/0277356 by Poruthoor et al. discussed above. The fibers may be staple or continuous or be formed in situ. As used in the specification and claims, the term “nonwoven composite substrate” includes and is not limited to a nonwoven or other polymeric substrate or film, or composite thereof.

These substrates are usually produced by loose entanglement of polymer fibers of varying diameters (that is, they are not woven like conventional cellulosic fiber textiles). There are several ways of producing such nonwoven substrates each with specific advantages. In a meltblown web formation, the molten polyolefin is extruded through appropriately shaped (usually circular) die capillaries and the fibers are reduced in diameter to approximately 10 microns upon exiting the die being carried by a high velocity gas (air) carrier stream that attenuates them and deposits them in a random manner on a collecting surface (see, for example, U.S. Pat. No. 3,849,241 to Butin et al.). The fibers are generally tacky when they are deposited on a collecting surface.

A spunbond method of producing nonwoven webs produces a nonwoven mat by extruding molten thermoplastic material through a plurality of appropriately shaped fine die capillaries and the diameter of the fibers is reduced upon exiting a die by eductive drawing or other spunbonding mechanism. Such production methods are described in U.S. Pat. No. 3,692,618 to Dorschner et al.; U.S. Pat. No. 3,341,394 and U.S. Pat. No. 3,338,992 to Kinney; U.S. Pat. No. 4,340,563 to Appel et al.; and other production methods known in the same field. The fibers exiting a die are generally not tacky when they are deposited on the collecting surface. The diameter of these fibers is usually between 5 and 40 microns, more often around 20 microns.

The fibers producing these mats can be made of a single component or multi-component (that is, made of at least two polymeric materials typically extruded separately but spun together to form the fiber). The location of each component is substantially constant along the length of the fiber. The fiber can take several different forms such as side by side geometry, pie geometry, and so on as taught in U.S. Pat. No. 5,108,820 to Kaneko et al.; U.S. Pat. No. 4,795,668 to Kruege et al.; U.S. Pat. No. 5,382,400 to Pike et al.; and so on. The cross section of the fibers can be regular shaped (for example, circular, oval or other regular shape) or irregular shaped (a star or other irregular shape).

In many cases, these nonwoven mats are used as laminates with polymeric films (polyethylene, polypropylene, polyesters (for example, PET, PBT and other polyesters)), and may also comprise polyamides, polylactic acid (PLA) and its derivatives, acrylics, styrene-based polymers, halogenated hydrocarbon polymers, vinyls, copolymers, polyvinylchloride and the like. The films used in these laminates may be continuous solid (impermeable) films, or engineered for a specific property. For example if breathability (high vapor transmission but no liquid transmission) is required, the film used to form the laminate may have a composition that includes a filler (for example, calcium carbonate) that creates micropores (highly tortuous paths) for gas transmission. A more detailed discussion of such breathable films used for example in manufacturing of personal care and hygiene items can be found in application US2008/0277356 by Poruthoor et al. discussed above.

Articles manufactured of nonwoven materials and laminates or composites of nonwoven materials are often intended to be convenience products, that is, used and disposed of. The application of inks and coatings can be done in any part of the manufacturing process, for example, printing or coating the nonwoven web before an intermediate nonwoven laminate is formed, printing or coating a surface after a laminate is formed, or after the final article is manufactured. The process of manufacturing a nonwoven substrate or an article comprising a nonwoven substrate or the method of printing or applying an ink or coating for printing thereon shall not be deemed to limit the scope of the printed/coated substrate or article as any known methods of manufacturing and printing or coating a nonwoven substrate are to be considered encompassed by the several printed substrate and article embodiments described herein.

For example, personal care (hygiene) products such as baby diapers, incontinence products, and training pants have a multilayer construction. A description of the layers may be conveniently from the inside (body-side) out, that is, a description may start with the layer that is in intimate contact with the body. As discussed above in respect to Poruthoor et al., U.S. 2008/0027356, the layer in intimate contact with the wearer's skin is a liquid permeable sheet generally termed a “topsheet” (for example, a nonwoven layer or a perforated film). The topsheet is a fluid acquisition layer and is typically engineered to absorb a liquid very quickly and move it to the subsequent layers and away from the body to create the perception of dryness and to increase comfort to the wearer.

Underneath the topsheet layer, there can be multiple layers of materials that manage the liquid flow and redirect it as desired. These layers can also be of nonwoven material, for example, with specifically engineered fiber materials and fiber structures, or multilayer structures. They also may serve to contain the next layer, the “absorbent core,” that has loose fibers and particles. Thus, absorption and storage of the bodily liquid is mainly occurring in the absorbent core, a layer of cellulosic fibers usually mixed (fluffed) with loose particles of superabsorbent polymers and odor management particles and the like. This is the most bulky part of the diaper/absorbent product. The absorbent core is usually supported and contained by a further layer of material that can also be nonwoven in nature.

The next layer is the outermost layer of a diaper or hygiene product, the so-called “backsheet,” preferably a layer engineered for breathability. It may consist of a breathable film (filled with a particulate filler and stretched, or a perforated film) or it can be a laminated or bonded structure where a polyolefin film (for example, polyethylene) is laminated to a nonwoven layer (typically polypropylene) to provide a cloth-like feel for the outermost surface of the diaper. This laminated structure can also be embossed, printed, coated and so on.

Printing of graphics for decorative purposes is normally done on visible surfaces of the backsheet structure, that is, on the polyethylene film sheet or on the outermost layer (nonwoven polypropylene that may be laminated or otherwise bonded to the polyethylene backsheet). In either case, the graphics printed on these layers of the product can be exposed to water, sweat, urine and other excrement, lotions, ointments, rash creams, baby oils and other similar liquids. It is desired that the graphics printed on the backsheet are desirably, highly resistant to these liquids.

Functional printing can be done on other surfaces of the product as well. For example, feminine hygiene products have printed areas that are visible to the user of the product (for example, on the topsheet or visible through the topsheet) and may be indicia related to the positioning and proper use of the product. Diapers can also have printed indicator graphics that change color or disappear when an insult of urine or other excrement occurs or when the holding capacity of the diaper is reached. Those usually are printed on the side of the backsheet facing the absorbent core.

In many cases, articles manufactured of nonwoven materials or laminates or composites of those materials have a limited life cycle, that is, they are designed to be used for a short time and disposed of. In the last few years, there has been a trend toward re-use or extending the life of convenience products. Such a trend has raised the bar for performance, for example, improved dry, saline and oil crockfastness. Consequently, these items now have to be more resistant to wear and abrasion, exposure to chemicals, and in some cases survive a few laundry cycles before disposal.

The general desired performance for a surface-printed nonwoven article such as the external surface of a baby diaper, for example, is to have desirable color strength and significant resistance to abrasion, so that color is not transferred from the nonwoven diaper to an item of clothing that comes in contact with it or with the baby's skin. Furthermore, the ink used to print such articles should not significantly degrade and transfer to a contact surface (such as carpeting, furniture fabrics, plastics and the like) when dry, or after contamination with body fluids (sweat, urine or other liquid excrement and the like) or personal care items commonly used on a baby's skin (for example, baby oil or rash cream). In summary, the ink used to print on such nonwoven materials may exhibit improved abrasion (rub) resistance dry or “contaminated” with certain test fluids (for example, saline and oil based fluids).

In accordance with an aspect of the present invention, a substrate is disclosed. According to an exemplary embodiment, a nonwoven composite substrate comprises one surface having deposited thereon a water-based aliphatic urethane composition. The composition optionally contains a carbodiimide crosslinker, the substrate and deposited composition having an oil crockfastness and a saline crockfastness in a range between about 2.8 to 5. In accordance with a further aspect, when the composition contains the carbodiimide crosslinker, the substrate and deposited composition have an oil crockfastness and a saline crockfastness in a range between about 3.0 and 5. Dry crockfastness values remain in the range between about 3.0 and 5.0 with or without the crosslinking agent.

In accordance with another aspect of the present invention, an article of manufacture is disclosed. According to an exemplary embodiment, an article of manufacture comprises a nonwoven composite substrate and the article of manufacture comprises one surface having deposited thereon a water-based aliphatic urethane composition. The composition optionally contains a carbodiimide crosslinker, the substrate and deposited composition having an oil crockfastness and a saline crockfastness in a range between about 2.8 to 5. In accordance with a further aspect, when the composition contains the carbodiimide crosslinker, the substrate and deposited composition have an oil crockfastness and a saline crockfastness in a range between about 3.0 and 5. Dry crockfastness values remain in the range between about 3.0 and 5.0 with or without the crosslinking agent.

In accordance with yet another aspect of the present invention, a polymeric film is disclosed. According to an exemplary embodiment, a polymeric film comprises one surface having deposited thereon a water-based aliphatic urethane composition containing a carbodiimide crosslinker. The film and deposited composition exhibit a dry crockfastness, an oil crockfastness and a saline crockfastness in a range between about 3.0 to 5. In particular, the test specimen comprises a thin, breathable polyolefin film.

In accordance with yet another aspect of the present invention, a method of manufacturing an article is disclosed. According to an exemplary method, the method of manufacturing an article comprises depositing thereon a water-based aliphatic urethane composition, optionally containing a carbodiimide crosslinker. The article of manufacture and deposited composition exhibit an oil crockfastness and a saline crockfastness in a range between about 2.8 to 5. When the composition contains the carbodiimide crosslinker, the article of manufacture and deposited composition exhibit an oil crockfastness and a saline crockfastness in a range between about 3.0 to 5. Dry crockfastness values remain in the range between about 3.0 and 5.0 with or without the crosslinking agent.

These and other aspects will be discussed with reference to the drawing and examples discussed in the detailed description, a brief description of which drawing follows.

### BRIEF DESCRIPTION OF THE DRAWINGS

FIG. 1 is a graph of color difference versus crockfast value for an abrasion resistance test conducted with reference to the examples and tables of results discussed herein.

FIG. 2 is a table showing the average number of rubs required for ink removal and color change on a Q-tip during three repetitions of an alkali resistance rub test for a benchmark ink that is not crosslinked and two different ink or coating compositions including one of Nisshinbo and Picassian carbodiimide as a crosslinker.

FIG. 3 depicts Table 1A providing finished ink or coating formulas for ink or coating examples 2A through 2D.

FIG. 4 depicts Table 1B providing crockfastness test results for ink or coating examples 2A through 2D compared with benchmark inks or coatings for dry crock, oil crock and saline crock tests.

FIG. 5 depicts Table 2 providing crockfastness and stability results comparing polyaziridine and carbodiimide as crosslinking agents for ink or coating examples 2A through 2D and benchmark inks or coatings with no crosslinking.

FIG. 6 provides results of abrasion resistance testing of a polyolefin film suitable for use as a backsheet of a hygiene product printed with ink or coating examples 2A through 2D crosslinked with Nisshinbo Carbodilite SV02 versus benchmark inks or coatings with no crosslinking.

FIG. 7 provides a table of several combinations of resins and pigment dispersions of about 8% pigment and 25% resin and dry, oil and saline crock test results.

### DETAILED DESCRIPTION OF THE EMBODIMENTS AND EXAMPLES

Throughout the detailed description, the term carbodiimide is meant to encompass any compound with a carbodiimide functional group, for example, polycarbodiimides, polyfunctional carbodiimides and multifunctional carbodiimides. The terms carbodiimide, polycarbodiimide, multifunctional carbodiimide and polyfunctional carbodiimide may be used interchangeably in the document. The term “multifunctional” or “polyfunctional” refer to a parametric term “functionality” known in the art as an average number of functional groups per molecule. Also, throughout the detailed description, the term “ink” refers to a typically pigmented composition and the term “coating” refers to a typically non-pigmented composition. The terms ink and coating may be used interchangeably and are intended to refer to the same composition which may, in one instance, be employed to print a substrate and in another instance to coat or partially coat a substrate or surface thereof. By “composition” as used in the specification and claims is intended either inks or coatings or both when used to print or coat one or more surfaces of a “substrate” as defined below. Abrasion resistance characteristics of a composition derive from the selected binder (polyurethane or urethane) for the composition. It is also understood that the application method of the composition (whether described as printing method or coating method) does not limit the scope of this invention, as the necessary rheological modifications of the composition and methods of achieving such modifications may be obvious to someone knowledgeable in the art.

As used herein, by the term “substrate” is intended any substance having a surface or a body which may be printed on or saturated with a composition, that is, printed with an ink or coating or coated with a coating. The term substrate is used broadly to describe any printable material that can be a web or sheet or intermediate manufacturing material or a final manufactured article. In particular, the term substrate may refer to a nonwoven surface as has been already defined in previous sections, a polymeric surface that is continuous (impermeable), or perforated, or engineered to requirements specific to its final application (e.g. be fibrillated or have specific surface treatments), or a laminate or composite formed from layering and bonding two or more layers to form a composite structure. The substrate can also be an impregnated nonwoven. Polymers that can be used in construction of such substrates have already been discussed and are well known in the art. Exemplary categories of substrates encompassed by this term comprise polymeric substrates, especially those of low polarity or non-polar substrates (for example, polyolefins, polyamides, polyesters, polylactic acid (PLA) and its derivatives, copolymers, polyvinylchloride and so on) including films and felts thereof.

The term crockfastness used in Examples 1 through 4 below refers to abrasion resistance characteristics (dry or wetted with a specific test fluid) of a substrate that has been printed or coated. Crockfast values or crockfastness as used in this application are based on the results of the test used, which is a modification of the method employed by Poruthoor et al. in 2008/02277356. Differences between our test method and standard AATCC methods are also discussed in the corresponding section.

Such a substrate used in Examples 1 through 4 below may be used in a variety of articles of manufacture which have been introduced above. A more extensive list follows of articles where some printing may be involved and some resistance to abrasion, water and oil resistance, seem to be a reasonable requirement. Some of the following categories may provide overlapping data. In a category of wipes (either disposable or durable), the following articles are contemplated and intended to be suggestive of yet other related articles in the same category: consumer articles: household, baby and personal care (feminine wipes, cosmetic removal wipes, sanitary wipes/towels); industrial articles: automotive industry, electronic and computer industries, cleanroom applications, janitorial, food industry and service, manufacturing, engineering and maintenance, medical/surgical, optical industries, office equipment, printing, transportation. In a category of filters, the following articles are contemplated and intended to be suggestive of yet other related articles in the same category: air intake/output, air conditioning and heating, industrial masks and respirator pads, household appliance filters such as vacuum cleaner filters, clean room filters, laboratory hood filters, battery separators, lab filters (for example, for blood purification, organic liquids), food filtration, water purification or desalination, coolant and cutting oil filters, swimming pool/spa filters, gasoline filters. In a category of hygiene product articles, the following articles are contemplated and intended to be suggestive of yet other related articles in the same category: baby diapers, training pants, pant diapers, adult incontinence diapers, pant diapers, disposable underwear, feminine products, for example, sanitary napkins, panty shields, tampons, nursing pads and underpads (bed or chair). In a category of apparel and home furnishings, the following articles are contemplated and intended to be suggestive of yet other related articles in the same category: clothing, protective apparel, outdoor wear, bedding, furniture (components or cover), window shades, wall coverings, awnings, tents and protective covers. In a category of medical applications or supplies, the following articles are contemplated and intended to be suggestive of yet other related articles in the same category: surgical gowns, booties, masks, hair coverings, drapes/curtains, gauze/wound dressings/bandages, medical hygiene products (also mentioned previously bedding, underpads, wipes and the like), medical/sterilization pouches and containers and patient care items. In an automotive category, the following articles are contemplated and intended to be suggestive of yet other related articles in the same category: trunk mats, a headliner, door trims and interior design material. In a category of geotextiles, the following articles are contemplated and intended to be suggestive of yet other related articles in the same category: landscaping textiles (weed control, seeding, root guard, barrier), crop cover (frost/insect/sun protection) and road construction (barrier, drainage) and the like.

As such, the following features of a water-based urethane printing composition using a carbodiimide as a crosslinking agent described briefly above will be discussed with respect to several aspects: 1) A water based polyurethane composition with significantly improved adhesion as well as oil, water and alkali rub resistance when compared with existing solvent based inks for nonwoven substrates and plastic films in general is described in Table 1B (Example 2A, 2B, 2C and 2D with no crosslinking agent); 2) Crosslinking with a multifunctional carbodiimide (at room temperature or preferably at temperatures slightly greater than 25° C. (77° F.)) offers even higher water resistance (See Example 3, Table 2, compositions of Table 1B, 2A, 2B, 2C and 2D including aziridine PZ-28 or carbodiimide SV02 as a crosslinking agent); and 3) Crosslinking the composition with carbodiimide significantly improves resistance properties (for example, saline [water] resistance and alkali resistance as well as oil resistance) and yields a composition with better viscosity stability than an aziridine-crosslinked composition; (see Examples 3 and 4). Viscosity stability enables stable press operation, good printability and longer post-inoculation life.

A low hazard, low toxicity rating of a polyfunctional carbodiimide makes it a safer choice than (poly)aziridines, and isocyanates, which are crosslinkers of high toxicity; (see Example 3, Table 2 for carbodiimide improvement in crockfast values). Carbodiimide offers reduced operational burden (no respirators may be required for employees in the vicinity of the printing process) and reduced operational cost.

A water based composition for substrates defined above (see Tables 2 and 3) using a non-toxic carbodiimide as a crosslinking agent, provides improved adhesion and abrasion resistance, both dry and in the presence of fluids like water, saline and mineral oil containing compositions (for example, baby oil). The ink or coating composition may comprise, in one embodiment, an aliphatic polyester urethane dispersion (PUD), a colorant (if desired), and small amounts of compatible additives like a defoamer, a rheology modifier, a wax and so on depending somewhat on the substrate but, more particularly, on the article of manufacture to be printed or coated.

Nonwovens for hygiene products that are surface printed are typically printed as laminated structures for easier web handling and transport using flexographic or rotogravure presses, but nonwoven substrates can also be printed before the lamination step. Flexographic printing is not required. Inkjet printing is another printing method that could be used to print such nonwoven substrates if the composition has appropriate viscosity and surface tension and is formulated with solvents suitable for the particular method of jetting. By digital printing as used for printing substrates and articles of manufacture discussed herein is meant any form of printing using digital data input and so printing output may be digitally controlled and represented in various means whereby digital image resolution may, for example, be represented in the form of picture or character elements. Screen printing or gravure printing can also be used, as well as other methods suitable for delivering the necessary amount of ink or coating composition to the nonwoven surface to produce a desirable graphic. Off-set printing is also intended to be incorporated as a method of printing a substrate or article of manufacture as discussed herein. Moreover, combinations of printing methods are contemplated, for example, where one printing method of printing a surface of a substrate is followed by printing another surface by a different printing method or printing another substrate of a composite by yet another printing method.

It is also understood that persons skilled in the art of coating compositions can engineer the rheological characteristics of the formulas exemplified here for use with other methods of applying a colored or colorless coating such as spraying, hopper or curtain coating, roller coating, blade coating and so on. The scope of the invention is not limited by the method of printing or coating on the substrate.

A typical flexographic solvent based ink formulation, for example, is described in Williams et al., US2008/0255275A1, discussed briefly above. Such a solvent based ink formulation may comprise a urethane solution (typically the resin solids are about 20-40% of the solution by weight) and a nitrocellulose pigment dispersion. The dry pigment usually represents approximately 10% of the total ink or coating composition. The resin and pigment are dispersed in a compatible mix of solvents such as acetates (propyl acetate, ethyl acetate, and so on), alcohols (ethanol, propanol, iso-propanol and other alcohols), glycol ethers (diethylene glycol propyl ether, diethylene glycol monobutyl ether, propylene glycol methyl ether, propylene glycol n-butyl ether and so on), esters, hydrocarbons and their modified products and so on. Other additives such as waxes (carnauba wax, Teflon, polyolefin wax an so on), plasticizers, silicones, stabilizers in small amounts (generally not more than about 5% of the total ink or coating composition) can be used to enhance the properties of the composition and reduce undesired artifacts such as foam on the press, any blocking of prints and so on. The viscosity of the final product is engineered to be appropriate for the printing or coating method used.

Water based compositions are usually thought to offer lower resistance properties than solvent based compositions, but the compositions discussed herein are more desirable because they have much lower VOC's (volatile organic compounds) than their solvent based counterparts, which are limited in their use to printers who are either permitted to release VOC's to the atmosphere or have solvent incineration equipment installed.

Previous applications for water based ink or coating compositions have demonstrated some abrasion resistance. For example, D. Steiner et al., WO2008/060855 disclose water based formulations based on polyurethane and polyurethane-urea dispersions that offer improved resistance versus formulations using other water based resin dispersions. The embodiments and exemplary aqueous ink and coating compositions disclosed therein comprise formulations of low VOCs that are based on polyurethanes and polyurethane-ureas based on mixed (aliphatic and aromatic) diisocyanates.

In Examples 1 through 4 discussed below, an aliphatic polyester polyurethane emulsion is used in an ink or coating composition, although other types of polyurethane solutions or emulsions may be suitable and exhibit similar performance. In general, the polyurethane resin(s) used in the ink or coating composition preferably:
1) Exhibit excellent adhesion to the printable surface of the film substrate or the fibers of the nonwoven web or laminate;
2) Exhibit low or no tendency to swell in the presence of oil or water;
3) Impart toughness and elasticity to the dried ink/coating and ability to maintain integrity of the ink/coating film under conditions of abrasion so that the dried ink/coating film is not easily attacked and plasticized by the oil or saline;
4) Form a film at relatively low temperature (about room temperature) and be relatively block resistant (heat resistant), so the glass transition temperature, Tg, of the resin(s) needs to be appropriately selected; and/or
5) Have functional groups that are reactive with carbodiimide chemistry (for example, carboxylic or amine or other functional groups) in a suitable average number density per molecule to produce a film of desired properties when crosslinked with an optimally selected carbodiimide containing compound.

Some polyurethanes have less desirable environmental or toxicological profile, for example, contain metal catalysts (tin), or solvents that are undesirable for printing operations (for example, NMP, amines and the like), but they may be suitable for industrial coating applications. Aromatic polyurethanes are thought to be of superior hardness, but have poor light stability. Aliphatic polyurethanes are preferred, and can offer competitive performance. Polyester, polyether, or polycarbonate polyurethanes are common in the coatings industry and can be used in the context of this invention as long as they present many of the properties discussed above. Polyurethanes suitable for use in this invention can be supplied by several manufacturers such as Reichhold, Bayer, Kane, Lubrizol, Rohm and Haas, Cytec, DSM Neoresins and so on.

Aliphatic polyester polyurethanes, such as a resin used in the exemplary ink or coating compositions of the Examples below, are produced by reacting diols and diacids to form the polyesters and then reacting the hydroxyl-terminated products with diisocyanate to form the polyurethanes. Diols defined by the formula R(OH)₂ wherein R is a straight or branched hydrocarbon chain may be used to form the polyurethane resins. Examples of preferred diols include polyethylene glycols (PEG), polypropylene glycols (PPG), polyester diols, polycaprolactone diols, dimethylolpropionic acid (DMPA), 1,4-butanediols, 1,6-hexanediols, polytetramethylene ether glycols (poly-THF or PTMEG) and mixtures thereof, with DMPA and poly-THF being particularly preferred. At least a monoamine or diamine can be employed as a further isocyanate reactive component. Any aliphatic, cycloaliphatic, aromatic, or heterocyclic amine having one or more primary or secondary amino groups, for example ethylenediamine, 1,2-diaminopropane, isophorone diamine, m-xylylene-diamine, hydrazine, 1,3-bis (aminomethyl) cyclohexane and so on. Aliphatic diisocyanates can be straight, branched or cycloaliphatic compounds comprising 1 to 10 carbon atoms. Examples of preferred such diisocyanates are 1,4-diisocyanatobutane, 1,6-diisocyanatohexane (HDI), 1,5-diisocyanato-2,2-dimethylpentane, 4-trimethyl-1,6-diisocyanatohexane, 1,10-diisocyanatodecane, 1,3- and 1,4-diisocyanatocyclo-hexane, 1-isocyanato-5-isocyanatomethyl-3,3,5-trimethyl cyclohexane (IPDI), 2,3-, 2,4-, and 2,6-diisocyanato-1-methylcyclohexane, 4,4′- and 2,4′-diisocyanato-dicyclohexylmethane, 1-isocyanato-3(4)-isocyanatomethyl-1-methyl-cyclohexane, 2,2,4- or 2,4,4-trimethyldiisocyanatohexane (TMDI), tetramethylxylene diisocyanate (TMXDI), and mixtures thereof. Aromatic diisocyanates also usually comprise 1 to 10 carbon atoms. Some examples of aromatic diisocyanates are 1,1′-methylenebis 4-isocyanato-benzene (MDI), and 1,3-diisocyanatomethyl-benzene (TDI). A diacid that is frequently used in polyester polyurethane manufacturing is 2,2-Dimethylolpropionic acid (DMPA), but other diacids may be suitable.

Other resins such as acrylic dispersions, solutions, and colloidal solutions, polyesters, maleic anhydride resins and half esters, and any polymer suitable for aqueous formulations can be present in an ink or coating composition used to print substrates discussed herein as secondary resins to improve certain aspects of the composition's performance. Secondary resin dispersions or solutions, when used, are present in small amounts, such as less than about 15 wt %, or preferably between about 0 to 10 wt % of the ink or coating composition.

Colorants such as several types of organic and inorganic pigment, pigment dispersions and dyes are suitable for water based compositions. Organic pigments may be one pigment or a combination of pigments such as Pigment Yellow numbers 12, 13, 14,17,74, 155; Pigment Red numbers 2, 22, 23, 48:1, 48:2, 52, 53, 57:1,122,116,170, 269, 266; Pigment Orange numbers 5,16,34,36; Pigment Blue numbers 15, 15:1, 15:3, 15:4; Pigment Violet numbers 3, 23, 27; and Pigment Green number 7. Inorganic pigments to be used can be iron oxides, titanium dioxides, chromium oxides, ferric ammonium ferrocyanides, ferric oxide blacks, Pigment Black number 7, and pigment white numbers 6 and 7. The colorant is usually present in the amount of about 0% to 40% by weight, preferably about 0% to 20% by weight of the ink or coating composition. Suitable dyes for use as colorants include but are not limited to azo dyes, anthraquinone dyes, azine dyes, xanthene dyes and combinations thereof.

In addition to water as the primary carrier for an aqueous ink or coating composition, organic solvents can be used in small amounts to improve composition performance. Organic solvents can be included in the composition formula as manufactured or just be recommended as press-side additions or dilution solvents to be added just before printing or coating. Examples are alcohols (ethanol, propanol, isopropanol), glycols and glycol ethers (monopropylene glycol, dipropylene glycol, 1-ethoxy-2-propanol, propylene glycol n-propyl ether, n-butyl ether, diethylene glycol monobutyl ether, propylene glycol methyl ether, diacetone alcohol) and so on. The solvent or mix of solvents may be present in small amounts usually between about 0 and 10 wt %, preferably less than about 5 wt % of the ink or coating composition.

The use of crosslinkers as press-side additions is known in the printing industry as discussed above. Aziridines, more specifically polyaziridines with more than two functional groups per molecule, are the most common crosslinkers used as press-side ink or coating composition additives. Such materials are commercially available, for example, as XAMA-2, XAMA-7 available from Bayer; CX-100 from Lubrizol; PZ-28 and PZ-33 from Polyaziridines, Inc. Typically a polyaziridine is added to a composition press-side in amounts less than about 20 wt % of the total composition. Aziridine rings (3-member nitrogen containing rings) react with carboxylic groups and create covalent bonds thus forming links between polymeric chains and creating a more resistant dried composition film. The crosslinking reaction typically occurs at room temperature and is driven by a drop in pH as the fugitive alkalis leave the drying film. Polyaziridines are also toxic and require the use of respirators for personnel handling the material, specifically where fine aerosol may be created, as may be the case with high speed printing. Polyaziridines also are known to create viscosity stability problems and have short post-inoculation life. In many cases, the composition “bodies up” or gels after inoculation leading to a short operation window and increased cost and waste, as press returns may be unusable in less than eight hours.

The use of other toxic crosslinkers like isocyanates is known and the use of melamines has also been suggested. On the other hand, carbodiimides, and more desirably multifunctional carbodiimides, comprise a class of non-ionic crosslinkers that react with amino and carboxylic groups of a resin and are non-toxic. They have been used, for example, in metallic coatings such as automotive coatings, industrial and architectural coatings and so on. This class of materials comprises oligomers or polymers that contain more than one —N═C═N— group per molecule. Early carbodiimides were subject to hydrolysis, needed a high reaction temperature (approx. 80° C.), and worked better in slightly acidic solutions; therefore, they were not adopted by the printing industry. Recently developed multifunctional carbodiimides are more robust and react at lower temperatures. Carbodiimides are commercially available from Nishinnbo (Japan) and also from Picassian Polymers (USA), and both are demonstrated in Example 1 which follows. Specific pigment dispersions may favorably interact with a polyurethane dispersion (PUD), more specifically, an aliphatic polyester polyurethane dispersion to yield more abrasion resistant compositions. Furthermore, the use of corona treatment and multifunctional carbodiimides in this system is shown to significantly increase the water resistance of the dried ink or coating composition. Multifunctional carbodiimides, as discussed herein, demonstrate superior parameters as crosslinkers for this system over the commonly used aziridines and isocyanates because they do not create rheological instabilities in the ink or coating system allowing for a gain in operational window for the printer, and they are much less hazardous to handle. Moreover, a carbodiimide retains a liquid or fluid character, for example, eight hours post inoculation while aziridines form a gel (which may, for example, impede a given printing process such as ink jet printing) of a nonwoven substrate.

An aliphatic polyester polyurethane emulsion, solution or dispersion, a colorant, and small amounts of compatible additives like a defoamer, a rheology modifier, a wax and so on yield a nonwoven ink or coating composition of superior dry and wet abrasion resistance. More specifically, a preferred composition of choice is given below in Table 1A by wt %. The amounts of resin and colorant can be varied to optimize the performance of individual colors. Co-resins can be used to optimize the performance further. Dyes and dye fixatives can be substituted for a dry pigment or a pigment dispersion. Other additives that perform similarly can also be substituted by someone knowledgeable in the art.

Two benchmark inks are used in the examples. Benchmark ink 1 is a commercially available solvent borne Sun Chemical product formulated specifically for dry abrasion resistance on nonwoven substrates. This is a urethane based product containing resin-supported pigment dispersion and additives and solvents. Benchmark ink 1 is used in examples involving nonwoven substrates.

Benchmark ink 2 is a modification of a commercially available solvent borne Sun Chemical product formulated for heat resistant application on plastic films. This is a plasticized nitrocellulose based product containing resin-supported pigment dispersion with additives and solvents. Benchmark ink 2 is used in a film substrate example, for example, involving printing a backsheet of a convenience product.

### Materials

The basic properties for a polyurethane solution or emulsion or dispersion that fulfill the requirements for successful application in this invention have been mentioned previously, for example, comprising an aliphatic polyester polyurethane solution, emulsion or dispersion (PUD shown in Table. Screening tests have been performed based on dry, oil, and saline crockfastness testing using simple compositions consisting of pigment dispersions and binders in the amounts that yield approximately 8 wt % dry pigment and 25 wt % resin solids including acrylics, styrenated acrylics, polyurethanes, self-crosslinking chemistries, polyvinyl alcohol, polyamides, vinyl acetate/ethylene copolymers, specialty copolymers and so on. Some of the resins and pigment combinations exhibited a reasonable oil resistance, but an aliphatic polyester polyurethane seemed to be a preferred candidate resin.

The disclosed examples of substrates are understood to encompass substrates printed with both pigmented inks as well as non-pigmented coatings. Thus, pigment dispersion (resin supported) is used in an amount of about 0.0-99.99%, yielding preferably less than about 20% of dry pigment, more preferably in the amount of about 5-10% of dry pigment in the total composition. In formulations disclosed herein, the inks or coating compositions may comprise epoxy ester pigment dispersions, but acrylic or surfactant-supported resin dispersions can be used as well. The pigment also plays a significant role in resistance performance. For example, epoxy ester dispersions with Y155 demonstrated improved resistance over Y14 and R269 demonstrated improved resistance over R57, all other compositional parameters being equal.

The inks or coating compositions used to print substrates for articles of manufacture as disclosed herein could also utilize other types of colorants. Examples of suitable colorants include, but are not limited to, dyes, organic or inorganic pigments. The dyes include but are not limited to azo dyes, anthraquinone dyes, xanthene dyes, azine dyes, combinations thereof and the like. Other organic and inorganic pigments and dyes can also be employed, as well as combinations that achieve the colors desired.

A thickener may be useful to bring formulations disclosed herein in the several examples to viscosities closer to those required for flexographic printing (measured to be approximately 23 seconds with a #2 EZ cup). In some examples with improved parameters, the final ink or coating compositions may have a surface tension lower than the surface energy of the substrate and viscosities suitable for flexographic printing. A preferred material for the example ink or coating composition is Acrysol RM2020NPR manufactured by Rohm and Haas. This thickener can be used in amounts up to about 20 wt %, preferably in amounts of less than about 1 wt % of the total composition. Acrysol RM2020NPR when used in our formulation exhibited nearly Newtonian behavior even at low and high shear rates. Other thickeners may also yield desirable rheological profiles and can be substituted by someone knowledgeable in the art.

A wax can be used to improve the dry abrasion resistance of the composition and decrease blocking on the take-up of a press. A preferred material is a micronized polypropylene wax, available as Propylmatte 31, manufactured by Micropowders. This wax can be used in amounts up to about 30 wt %, preferably in amounts of less than about 5 wt % of the total composition. Dispersed (formulated) waxes are also available from other manufacturers and can be substituted by someone knowledgeable in the art.

Finally, a defoamer can be used to keep the compositions foam free on the press. A preferred material is Drewplus L493, manufactured by Ashland. The defoamer can be used in amounts up to about 20 wt %, preferably of less than about 2 wt % of the total composition. Other defoamers are also available by other manufacturers and can be substituted by someone knowledgeable in the art.

The ink or coating compositions of the several examples could also contain other functional components either solubilized or as a stable dispersion of particles of nano to micron size that can be used to impart a specific function or property to the coated substrate.

Examples of these components include ultraviolet (UV) protectants such as for example benzophenone derivatives like Tinuvin 26 and Chimasorb 81. These can be used to protect some of the other active components in the coating from being attacked by UV radiation. Such protection can be especially important for outdoors applications. Other exemplary protectants include Tinuvin 494 and Chimasorb 119FL.

Another additive component may be a biocide with similar function as those found in infection control items such as bleach, or bleach precursors, for example, Alphasan antimicrobial particles available by Milliken; colloidal silver and so on.

Yet another additive component may be an antifungal agent such as, for example, the Alphasan series of products and zinc omadine by Arch Chemicals; the Ultrafresh series of products available by Thompson Associates; Kathon LM by Rohm and Haas; and so on.

Various stain and soil repellants and oil repellants may be added to a preferred ink or coating for a particular article of manufacture. In addition to the typical waxes and PTFE these materials, an additive may be a fluorochemical like the Scotchguard series of products by 3M; Zonyl series by Dupont; and Repearl series by Mitsubishi; and non-flurochemical based stain release agents such as ethoxylated polyesters, sulfonated polyesters, ethoxylated silicone polymers, ethoxylated nylons and so on. Silicones can also be used as a repellent.

Pesticides such as insecticides may be added in amounts depending on the article of manufacture selected among commercially available pyrethroid compounds such as Etofenprox, Fenvalerate, Cycloprothrin, Fluvalinate, Cyphenothrin, Acrinathrin, Tetramethrin and the like; carbamate compounds that are preferably used not in combination with pyrethroids such as Bendiocarb, Fenoxycarb, Alanycarb, Isoprocarb, Pirimicarb and so on; and organophosphorous compounds such as Phenthion, Etrimphos, Fenitrothion, Diazinon, Pyridaphenthion, Phoxim, Cyanophos, Malathion, Azamethiphos and so on.

Scents and oils may be useful to attract or repel: formulated fragrances or oils, for example, peppermint oil, basil oil, orange oil and lemon oil are considered pleasant and can have pain relieving/refreshing effects to humans; tea tree oil may be used to repel fleas. Cats can be repelled by allyl isothiocyanate (oil of mustard), amyl acetate, capsaicin, eucalyptus oil. Mosquitoes may be repelled by citronella oil and chemicals like DEET, DEPA and MNDA, by way of example. Insect or animal attractants/repellants are specific to each species and can be, for example, certain pheromones.

Controlled release particles such as those found in scent-dispensing particles (euphoriants) or pain reducing substances (pharmaceuticals) and particles that can absorb chemical vapors and odors may be used, for example, in hazard containment and terrorism countermeasure applications: activated carbons, zeolites, zinc oxide particles, diatomaceous earth and any other such particles of high micropore volume and surface area (preferably 500-1500 m2/g).

Nano- and micro-sized materials and fillers can enhance mechanical properties of an article of manufacture such as silica, colloidal silica, alumina, zirconia, zinc oxide, titanium dioxide, precipitated CaCO₃ (typically used, for example, in hygiene product backsheet construction), carbon, graphite, metal salts, silica-coated metal powders and so on.

Materials that can provide flame retardant properties include zinc borate and antimony pentoxide and polymers specifically engineered to impart fire-retardant properties and so on.

Nano- and micro-sized materials that enhance the electrical conductivity include carbon nanotubes, colloidal silver, antistatic agents such as the Zelec™ products available by Milliken, and so on.

Furthermore, the addition of multifunctional carbodiimides, as disclosed in several embodiments of compositions used herein for printing substrates, in amounts up to about 30 wt %, preferably at levels of approximately 4-5 wt % of carbodiimide solids in the total formulation is shown to significantly increase the water resistance of the dried composition. This may be due to increased crosslinking density and improved adhesion by chemical bonding to the substrate. Multifunctional carbodiimides are demonstrated in the several examples as crosslinkers which improve the qualities of the printed substrates over use of other cross-linkers, for example, over the commonly used aziridines because carbodiimides do not create rheological instabilities in the ink system allowing for a gain in operational window for the printer. Carbodiimides are much less hazardous to handle and retain a liquid or fluid composition longer post inoculation.

A preferred carbodiimide material is a water based multifunctional carbodiimide, in particular, Carbodilite SV02 at 40% solution manufactured by Nisshinbo Industries (JP). A suitable carbodiimide crosslinker solution may be present at about 1 to 30 wt % of a total fluid formulation. Carbodilite SV02 has a relatively high functionality (where functionality is indicative of the number of functional groups per molecule) and works best at slightly elevated temperatures (>25° C.). Picassian Polymers (USA) and other manufacturers have also commercialized polycarbodiimide solutions and may be substituted by someone knowledgeable in the art. Indeed, a Picassian carbodiimide is used in example 2A below.

This polycarbodiimide crosslinked composition yielded superior wet abrasion resistance and viscosity stability. Example 2, Table 2, demonstrates the abrasion performance improvement and superior viscosity stability achieved by a polyurethane ink or coating composition when crosslinked with a polycarbodiimide versus a polyaziridine having a functionality of about 3. Similar ratios of resin solids to crosslinker solids were used for both examples.

### Abrasion Resistance Test Method (Crockfastness Test Method)

A modified version of the American Association of Textile Chemists and Colorists (AATCC) Test Method 116-1983 described in U.S. Pat. No. 5,695,855 to Yeo et al. was used to measure whether the combinations of corona treated nonwoven substrates and compositions had sufficient abrasion resistance. Subsequent versions of the AATCC Test method 116 (like the current 116-2005) are also similar in essence and are included herein. The test method employed in the examples is closely related to that described by Poruthoor et al. in US2008/0227356. The main differences between the methods used below and the AATCC and Poruthoor et al. methods will be highlighted in the discussion below.

The AATCC Test Method 116-1983 uses a device called a Rotary Vertical Crockmeter to rub a piece of test fabric against the sample specimen. The modified crock test method used below (similarly to that described by Poruthoor et al. in US2008/0227356) employed a device called a Sutherland Rub Ink Tester (Sutherland Paper Company, Kalamazoo, Mich.) as an alternative to the Crockmeter. The Sutherland Rub Tester is used in the printing industry to evaluate the resistance of inks and coatings on printed substrates. The Sutherland has a broader test area than the Crockmeter. The Sutherland test head is 2″×4″ area for an eight square inch test area. This test head is moved laterally over the printed test specimen in a shallow arc pattern. Various weights are available to alter the pressure on the test surface and the number of test “strokes” is variable. The crockfastness test of Poruthoor et al. in US2008/0227356 uses a 4.0 pound weight and 50 rub strokes at a frequency of 42 cycles per minute. This condition was used in the examples below as well as a modified version of this test (with a 2 pound weight) for Example 4 of abrasion resistance on thin breathable films (backsheet) because of the delicate structure of the substrate. The test specimen may be abraded against any material that can be readily attached to the opposing surface of the tester, for example, Standard CROCK 6 cotton cloth test swatches (sized 2″×6″) available from Testfabrics of West Pittston, Pa.

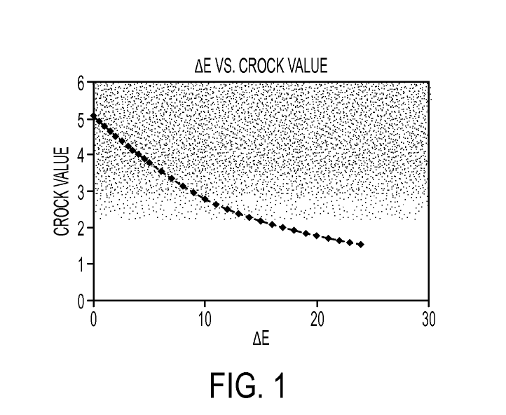

Under the AATCC method, after the abrasion test is completed, any resulting transfer of colorant from the printed substrate to the test specimen (crock cloth) is qualitatively rated from one to five against a standard scale. A five is equivalent to the absence of transfer and a one is equivalent to an extreme amount of colorant transfer. The primary difference between the test method used in the following examples and the AATCC method was a quantitative method of measuring color transfer and assigning a colorfastness value. A spectrophotometric device can be used to measure the color difference value of a test specimen from a standard benchmark, which can be a similar white test cloth without any colorant on it. This color difference under D50 light source and 10 degrees observation angle is measured in ΔE units. Poruthoor et al. in US2008/0227356 also use a similar color measurement method instead of a comparison to a standard. In the examples below, a spectrophotometric measurement on EyeOne-iO Spectrodensitometer by Gretag was used to measure ΔE, but unlike Poruthoor et al., to measure the reflection mode spectra of a regular pattern of 50 patches on the 2″×4″ rub area (5×10 patches respectively) of the test specimen. The spectra of a similar pattern of 50 patches were measured on a white (reference) test cloth. From these 50 pairs of spectral data, the average color difference (in ΔE units) between the test cloth and the white reference cloth was computed; see FIG. 1. The same equation described by Yeo et al. in U.S. Pat. No. 5,695,855 and by Poruthoor et al. in US2008/0227356 was used to convert the average color difference value (measured in ΔE units) into crockfast value equivalent to the AATCC colorfastness scale. A graph is provided in FIG. 1. The following equations were used:

If ΔE<12, then crockfast value=5.063244·exp(−0.059532·ΔE).

If ΔE≧12, then crockfast value=4.05661216·exp(−0.041218·ΔE).

The crockfast value scale that is created in this manner ranges from 0 to 5 and yields low numbers for high color transfer and high numbers for low color transfer.

With the automated Gretag Spectrodensitometer, greater objectivity in evaluating the results was possible due to less operator dependence. It is also possible to achieve higher efficiency and consistency. Again referring to FIG. 1, there is shown a plot of ΔE vs. crockfast value according to the equations above for high color transfer and high numbers for low color transfer. The following is a summary of equipment and materials used to perform crock tests:

### Crockfastness Test—Equipment and Materials Used

1. Corona treater, 0.5 KW unit

2. Pamarco proofing equipment, Pamarco, Summit, N.J.

3. Sutherland 2000 Rub Tester (Sutherland Paper Company, Kalamazoo, Mich.) equipped with rubber pads

4. Crock cloth, standard cotton 2″×6″ from Testfabrics, West Pittston, Pa. (approximately 50 mm×152 mm) rectangular test swatch.

5. Laboratory standard ambient conditions: temperature=22±2° C. and relative humidity=50±10%.

6. Eye One-io Spectrophotometer (Gretag)

### Crockfastness Test Procedure

The test specimens were plastic films (Example 4) or nonwoven polypropylene web and film laminates (Examples 1-3) as further specified below in the Examples. The test specimens were cut to 4 inches wide by 11 inches long (long side along the machine direction), unless otherwise noted, with the test area centered on the square and labeled. The samples that received the example aqueous compositions were corona treated to 70 Wmin/m² energy density. The samples that received the Sun benchmark inks 1 and 2 were not corona treated, as corona treatment is not usually recommended or deemed necessary for improving adhesion for such solvent borne inks. All prints were printed on a Pamarco pneumatic controlled printer (Pamarco, Summit, N.J.) with constant pressure (40 psi) using a handproofer with 165 lpi and 9.2 bcm. They dried at 50° C. for 30 sec and were allowed to age overnight (at least 16 hours). Rub tests were performed as described below.

A protective soft film (Parafilm) was used to cover the surface of the rubber pad on the rub tester to avoid contamination during wet tests. The printed sample was centered onto the base of the rub tester so that the printed surface faces up and the area to be tested was centered.

A thin protective sheet (Parafilm) was used to cover the 4 lb weight of the Sutherland tester. A white 2″×6″ cotton sheet marked with the individual sample information was placed over the protective sheet and adhered using double sided tape on the side walls of the Sutherland weight, in a manner so that the tape would not interfere with the rub area.

The crock cotton cloth was evenly wetted with baby oil (Johnson's baby oil, by Johnson & Johnson Consumer Companies, Inc), or saline solution (Sensitive Eyes Plus, by Bausch & Lomb, Inc) bringing the wet pickup to 0.35 g per cotton cloth. When measuring the dry abrasion resistance, this step was omitted.

The Sutherland weight bearing the white cloth sample was attached to the rub tester arm with the white cloth surface contacting the print to be tested and the rub tester was set for 50 rub strokes (one stroke=back and forth movement) at 42 cycles per minute. Once the rub testing for a batch of samples was completed color difference measurements began. However, crock samples that were saturated with water or oil were allowed to dry in an open area for a few hours before color difference measurements were undertaken.

The EyeOne-iO instrument was calibrated automatically to its white spot before each measurement. The test specimen (crock cloth) was placed on the white measurement tray of the instrument. Fifty spectral measurements on a regular pattern (5×10) on the 2″×4″ rub area of the crock cloth were taken. Spectral data of a reference white cloth were measured in a similar manner and stored as a reference for comparisons. From these 50 pairs of spectral data, the total color difference between the test specimen and the reference white was calculated under D50 light source and 10 degrees observer angle (in ΔE units). Crockfast values (crockfastness) between 0 and 5 were computed from the average total color difference using the equations shown in the previous section, and these crockfast values are also depicted in FIG. 1.

### Crockfastness Test Evaluation

Each specific ink or coating composition was tested at least twice, preferably three times, to obtain an average reading. The average was determined by individually calculating the crockfast value for each of the test specimens, summing the crockfast values, and then dividing by the number of samples to get the average crockfast value.

### Alkali Resistance:

Another area where the water based ink or cating compositions discussed herein show improvement over comparative inks is in alkali resistance of dried prints.

### Alkali Resistance Test Method

The test used here consisted of saturating a Q-tip in a solution of about 5% ammonia solution in deionized water and rubbing at approximately a 45 degree angle a 1-inch long area on the printed substrate while applying index-finger pressure on the Q-tip stem.

The Q-tip stem was rotated 180 degrees between rubs to supply a nearly homogeneous content of ammonia solution on the cotton tip with ever rub and avoid drying of the cotton tip on one side. The Q-tip rubs were stopped when there was evidence of ink removal from the substrate and the Q-tip was visibly colored.

### NONWOVEN EXAMPLES

### Example 1

### Alkali Resistance

The substrate test specimen used in this and all examples, except Example 4, was a polypropylene nonwoven laminated on a polyethylene sheet of typical basis weight, for example, about 50 g/square meter, suitable for diaper backsheet or other hygiene product and useable in other convenience articles of manufacture. In particular, the test specimen comprised a non-woven laminate having a nonwoven side, on which side a composition is deposited, consisting of polypropylene fibers laminated to a polyethylene sheet. Such a nonwoven substrate being within the generic category of a polyolefin is known to be of low surface energy and consequently poor wetting and adhesion of ink and coating compositions. Such a non-woven substrate would then exhibit a worst case scenario when considered with other categories of non-woven substrates including those mentioned above including but not limited to polyamides, polyesters, polylactic acid (PLA) and its derivatives, copolymers and polyvinylchloride. Printing was done with a handproofer with 165/9.2 anilox, and the prints were dried at 50° C. for 30 seconds.

Now the alkali resistance testing process will be described in greater detail. The prints or coated substrate specimens were aged for at least one hour before testing. The red compositions used were of the same formulations as listed in Example 2. Sun Benchmark 1 is the benchmark ink and was not crosslinked in Example 1; see Table 1A.

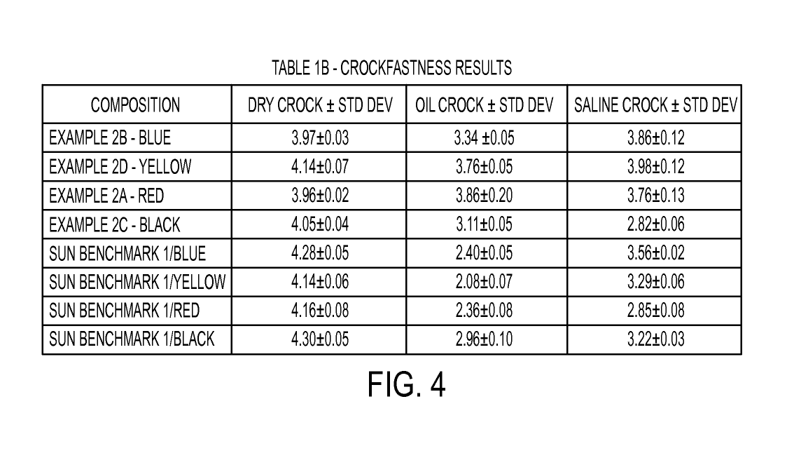

Referring to FIG. 4, example ink or coating compositions for printing a nonwoven substrate having further improved parametric results were those crosslinked with Nisshinbo Carbodilite SV02 (sold as 40% solution) per Example 2, Table 1B. A suitable carbodiimide crosslinker may be present at about 1 to 30 wt % of a total fluid formulation. Another manufacturer's multifunctional carbodiimide crosslinker was also tested (XL-702 by Picassian, also sold as 40% solution) with the ink or coating composition described in Example 2 of this invention. In both cases, about a 12% cut of the composition with water was made before printing on the substrate (a viable range being about 8-15%). By way of example, twelve grams of crosslinker may be used with 100 grams of solution. Mathematically, 12 w % cutting by water yields 112 grams of solution while 40% solution multiplied by 12% cut yields 4.8 grams of carbodiimide Dividing 4.8 g by 112 g total yields 4.28 wt % of carbodiimide in the carbodiimide examples.

### Alkali Resistance Rub Test Results

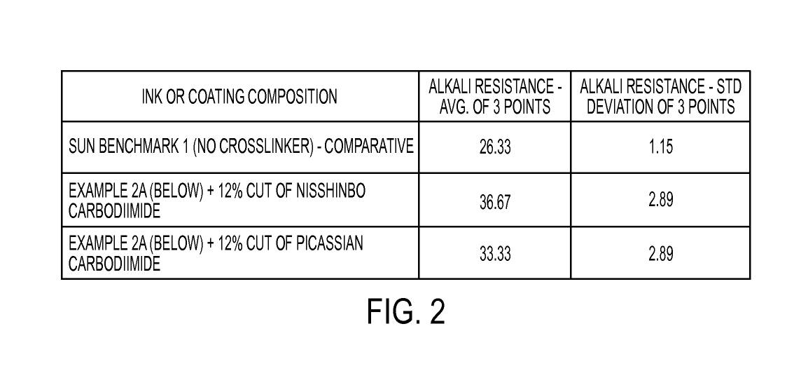

Referring now to FIG. 2, the figures in the depicted chart represent the number of rubs required to show both ink removal from the substrate and noticeable color change on the Q-tip. The Nisshinbo carbodiimide demonstrated a 3 point improvement in alkali resistance over the Picassian carbodiimide The rub test was repeated 3 times for each composition and the average of the 3 results is shown in FIG. 2 along with the standard deviation figures:

### Example 2

### Finished Ink or Coating Compositions

Example 2 demonstrates the final performance of a fully formulated ink or coating composition based on a suitable aliphatic polyester polyurethane dispersion (PUD) and epoxy ester pigment dispersions for each color. Table 1A provides finished composition formulas used in printing substrates and articles of manufacture as discussed above by the method discussed above. Table 1B summarizes dry and “wet” (baby oil, and saline) crockfastness results for Examples 2A-2D versus the Sun Benchmark 1 inks with no crosslinking agent. The following formulations for Example 2A (red), 2B (blue), 2C (black), and 2D (yellow) received a cut with water of between about 0 and 10wt % and preferably about 2-5% by weight (that is, about 2-5 grams of water were added to 100 grams of composition) to bring the viscosity to about 22″±2 number 2 EZ cup.

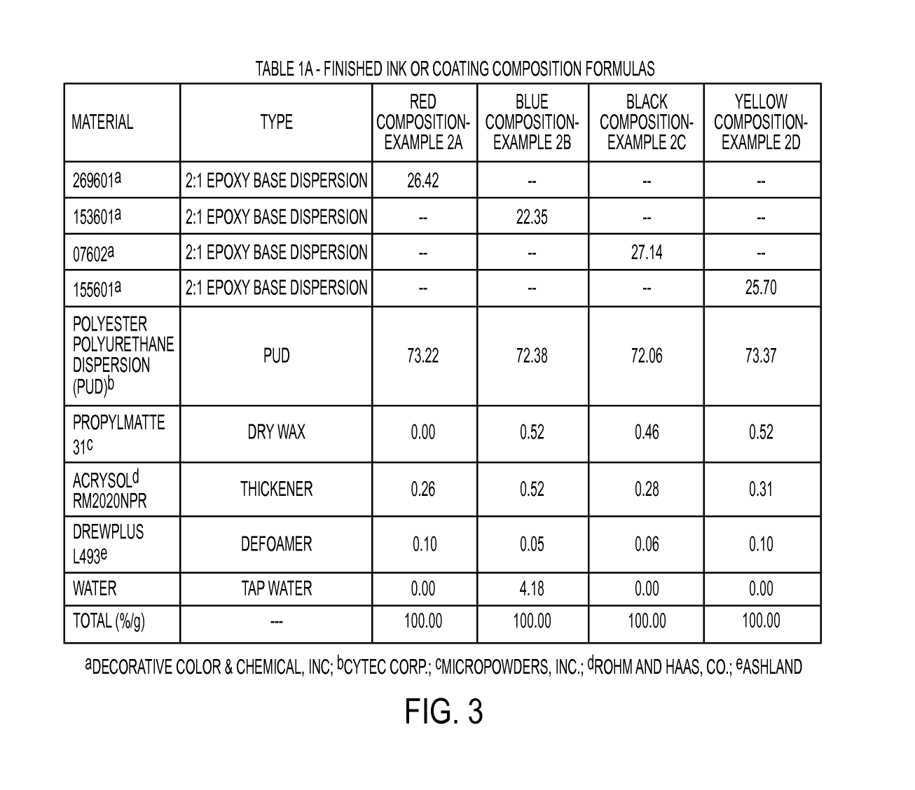

Referring to FIG. 3, the compositions in depicted Table 1A were tested for crockfastness using the test methods described above. Note that the type of pigment dispersion used is a 2:1 epoxy based dispersion where 2:1 is the pigment to resin ratio. The results shown in Table 1B for Examples 2A through 2D are not crosslinked. For comparative purposes, the benchmark product used is Sun Chemical Benchmark 1 described above—a solvent-based commercial product that contains resin-supported pigment dispersion, a polyurethane, solvents and additives. The Benchmark 1 inks were cut to 25±1″ number 2 EZ cup. All compositions, including the Sun Benchmark 1 exhibited excellent dry crock results of between 3.9 and 5.0. Note that with the ink or coating composition of Examples 2A-2D, an improved oil crock and saline crockfastness result was achieved over the Sun benchmark 1 ink from 3.06 (Sun benchmark 1 black, best benchmark value) to 4.06 (Example 2A red) for oil crock and 3.58 (Sun benchmark 1 blue) to 4.1 (Example 2D yellow) for saline crock including the standard deviation.

### Example 3

### Addition of Crosslinking Agent

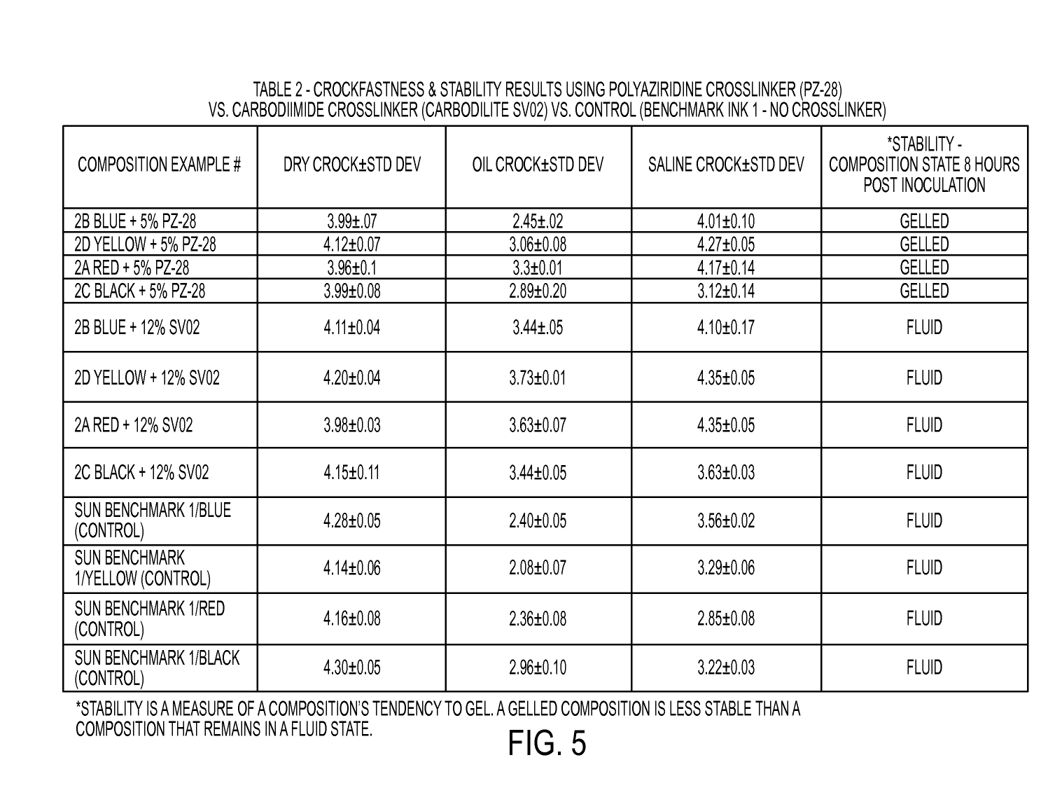

Referring to FIG. 5, presenting Table 2, further performance improvements (saline crockfast value) can be achieved with the use of a carbodiimide crosslinker (Carbodilite SV02 by Nisshinbo Industries, Inc), which was preferred over a polyaziridine (PZ-28 by Polyaziridine, LLC) for its non-toxicity and liquid form. SV02 is supplied at 40% carbodiimide solution. Thus the final amount of carbodiimide solids in the example compositions is approximately 4.28 wt % or approximately 4.3% by weight of the cut composition as calculated above. Sun Benchmark 1 inks were used for comparative purposes and do not contain crosslinker, since they are not designed as crosslinked inks. Dry crockfastness results for all compositions were excellent for, for example, non-woven substrates and articles of manufacture as discussed above. Saline and oil crockfastness for polycarbodiimide are comparable, if not improved, over those for polyaziridine PZ-28 (for example, oil 3.31 for 2A red aziridine and 3.70 for 2A red carbodiimide with the standard deviation). Note that the stability of polyaziridine ink or coating compositions eight hours post inoculation indicate gelling while SV02 remained fluid.

### Plot of ΔE vs. Crockfast Value as Referenced in Abrasion Resistance Test Method

FIG. 1 represents a plot of the following 2 equations described in the Abrasion Resistance Test Method above:

If ΔE<12, then crockfast value=5.063244·exp(−0.059532·ΔE).

If ΔE≧12, then crockfast value=4.05661216·exp(−0.041218·ΔE).

The plot shows the correspondence of the color difference that measured for the crock cloth (after the rub test) to the crockfast value that reported as a result in the examples/tables.

The measured difference in color is from a similar white cloth and occurs because (with the rubbing action) a non-resistant coating gets compromised and pigment transfers to the crock cloth.

### Example 4

### Abrasion Resistance of a Polyolefin Film Suitable for Use as a Backsheet of a Hygiene Product

The following example demonstrates the final oil and saline rub performance of the fully formulated ink or coating composition as described in Example 2 crosslinked with SV02 on a breathable polyolefin (polyethylene) film of a thickness of about 22 microns that is suitable for use, for example, in a backsheet of a hygiene product generally described herein as a polymeric film. The substrate “as received” was marked “treated.” A thicker polymeric film may be used, for example, as a geotextile in the manufacture of landscaping and construction bags, tarps and the like. Again, a polyolefin class of films may be considered a worst case scenario as representative of categories of film substrates that may be printed or coated and comprise articles of manufacture described herein for testing for crockfast values.

The example compositions were formulated as in Example 2 and received about a 2-5 wt % cut with water to bring the viscosity to 22″±2 number 2 EZ cup, that is, 2-5 grams of water were added per 100 grams of ink. Furthermore, about a 12 wt % cut with a polycarbodiimide crosslinker (Carbodilite SV02 by Nisshinbo), as above, was used to achieve the best performance. The substrate printed with the example compositions was corona treated under conditions described before.

The benchmark inks (Sun benchmark 2 being different from Sun benchmark 1) are a commercially available solvent borne product by Sun Chemical that can be used on polymeric films. The Sun benchmark 2 inks contain resin supported pigment dispersion, plasticized nitrocellulose, solvents and additives. These inks were provided at nominal viscosities of approximately 40-45 sec #2 EZ cup and were cut by about 20% with a mixture of appropriate solvents (80/20 n-Propanol/n-Propyl acetate) to press viscosity by volume. As discussed before prints of the benchmark inks were made without any additional corona treatment of the substrate, and they were not crosslinked.

All prints described in this example were tested using a modified Sutherland rub method employing a lower weight (2 pounds instead of 4 pounds) and the same number of strokes as described in the body of the invention. This modification of the test was necessary because of the very delicate nature of the printed substrate.

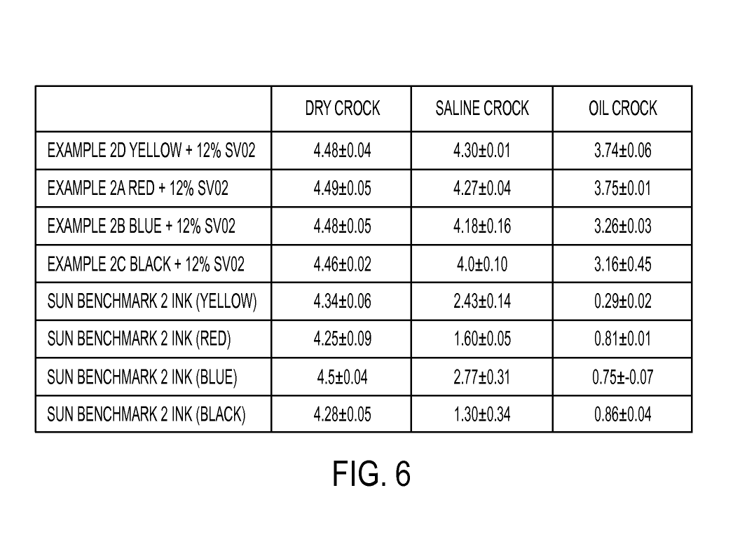

The results of abrasion testing are provided in FIG. 6.

From the data above, it appears that, for example, a polymeric film suitable for use in a backsheet of a hygiene product or other film substrate printed with a composition formulated according to Example 2 offers a significant performance improvement in saline and oil resistance over the benchmark ink and comparable dry crockfastness. Note that saline and oil crockfast values (crockfastness) between 3 and 5 were measured for each of Examples 2A through 2D, but that a lower weight value was used in the Sutherland rub test so as not to damage the thin film test specimen.

### Screening of Resins

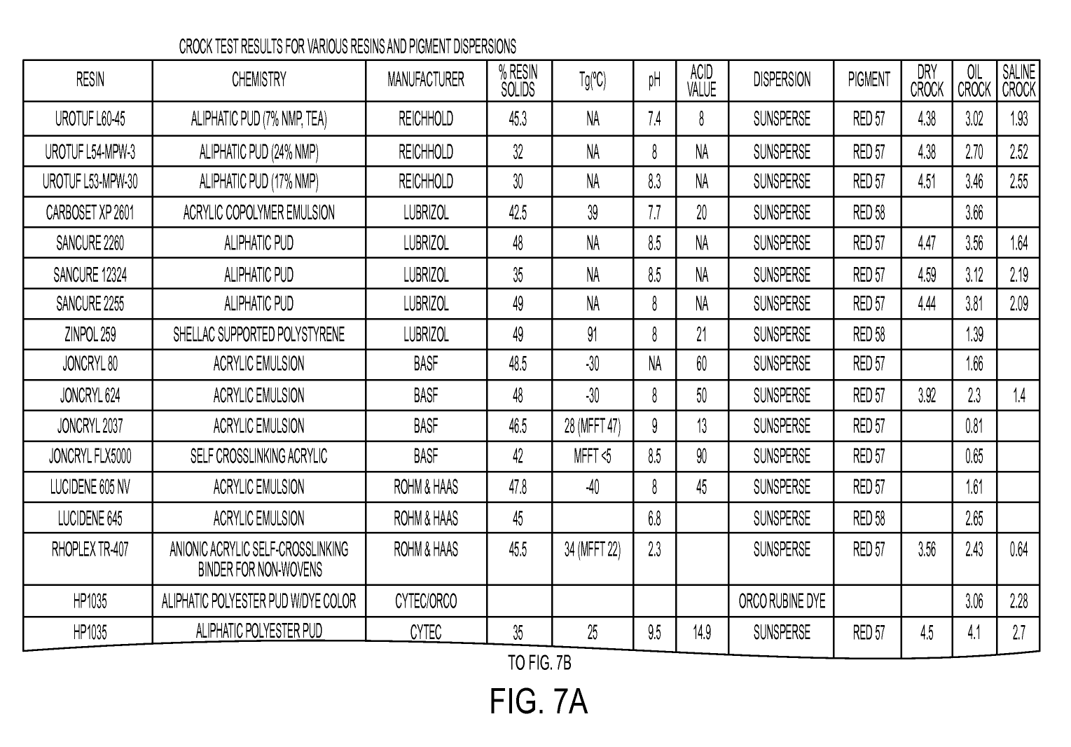

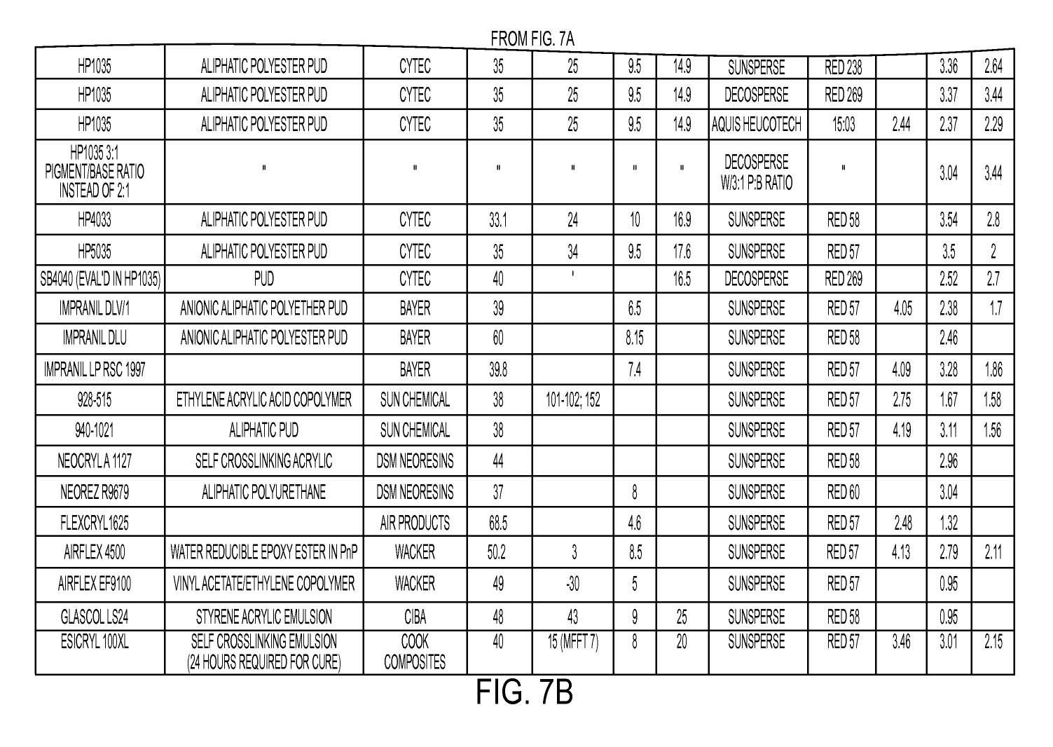

Referring to resin table FIG. 7, it is shown that many combinations of resins and pigment dispersions exhibit good results and could be used in the non-woven composites.

These screening experiments were conducted with mixes of pigment dispersion and resin emulsion or solution to yield a final composition of 8% pigment and 25% resin. No other additives were used. Details for experimental procedure are as outlined in the testing procedure section above. The table below summarizes dry and “wet” (baby oil, and saline) crockfastness results for a variety of resins from polyurethanes, acrylic resins, self-crosslinking resins, specialty copolymers and so on along with a variety of pigment dispersions.

Thus, there have been shown and described several examples of substrates, articles of manufacture, methods of manufacture and a polymer film having an aqueous polyurethane composition deposited thereon high dry, water, and oil abrasion resistance. Improvements over the benchmark inks were noted and further improvements have been achieved using a carbodiimide as a crosslinking agent without toxicity and allowing the exemplary compositions, optionally including a carbodiimide crosslinker, and using the several printing processes discussed herein, to remain fluid, for example, eight hours post inoculation. Other embodiments may come to mind of one of ordinary skill in the art from a study of the description of the embodiments discussed above. Compositions by wt % may be assumed unless otherwise indicated throughout. All United States patents and United States and WIPO published patent applications discussed herein should be deemed to be incorporated by reference as to their entire contents. The substrates and articles of manufacture should only be deemed to be limited by the scope of the claims which follow.

What is claimed is:

1. A nonwoven composite substrate comprising
(a) one surface having deposited thereon a water-based aliphatic urethane composition, optionally containing a carbodiimide crosslinker, the substrate and deposited composition having an oil crockfastness and a saline crockfastness in a range between about 2.8 to 5; and
(b) the nonwoven composite substrate.

2. The substrate according to claim 1, wherein said substrate is comprised of polyolefin.

3. The substrate according to claim 1, wherein said substrate is comprised of a polyamide.

4. The substrate according to claim 1, wherein said substrate is comprised of a polyester.

5. The substrate according to claim 1, wherein said substrate is comprised of a polylactic acid and its derivatives.

6. The substrate according to claim 1, wherein said substrate is comprised of a copolymer.

7. The substrate according to claim 1, wherein said substrate is comprised of a polyvinylchloride.

8. The substrate according to claim 1, wherein the substrate is manufactured as one of a laminate, a wipe, an article of clothing, a shopping bag, a landscaping bag and a hygiene product, a component thereof comprising one of a top sheet, a backsheet, an absorbent core and any intermediate layer thereof.

9. The substrate according to claim 1, wherein said composition is deposited by a printing method comprising one of flexographic printing, rotogravure printing, inkjet printing, digital printing, screen printing and off-set printing or combination thereof.

10. The substrate according to claim 9, wherein said printing method comprises a 4-color printing process.

11. The substrate according to claim 9, wherein said printing method includes one of spraying, hopper or curtain coating, roller coating and blade coating.

12. The substrate according to claim 1, wherein said composition comprises an aliphatic polyurethane.

13. The substrate according to claim 1, wherein said composition comprises one of a polyester, a polycarbonate and a polyether.

14. The substrate according to claim 13, wherein said composition comprises one of an emulsion, a solution and a dispersion.

15. The substrate according to claim 14, wherein said dispersion comprises a polyester polyurethane dispersion.

16. The substrate according to claim 1, wherein said composition further comprises an organic solvent.

17. The substrate according to claim 16, wherein the organic solvent is selected from a group consisting of alcohols, glycols, and glycol ethers.

18. The substrate according to claim 16, wherein the organic solvent is present in a range of about 0 to 10 wt %.

19. The substrate according to claim 18, wherein the organic solvent is present in the range of about 2 to 8 wt %.

20. The substrate according to claim 1, wherein said carbodiimide crosslinker is a multi-functional carbodiimide crosslinker.

21. The substrate according to claim 20, wherein the crosslinker may be present in a range of about 1 to 30 wt % of a total fluid composition.

22. The substrate according to claim 20, the substrate and deposited composition having a dry crockfastness, an oil crockfastness and a saline crockfastness in a range between about 3.0 to 5.

23. The substrate according to claim 1, wherein the composition further comprises one of a dry pigment, a pigment dispersion or a dye or combination thereof.

24. The substrate according to claim 23, wherein the pigment dispersion is in the form of an epoxy based dispersion.

25. The substrate according to claim 24, wherein the epoxy based dispersion is present in concentrations of ratio of about 2:1, pigment dispersion to resin.

26. The substrate according to claim 23, wherein the pigment or pigment dispersion or dye or combination thereof may be present in a range of about 0 to 99.99 wt %.

27. The substrate according to claim 26, wherein the pigment or pigment dispersion or dye or combination thereof may be present in the range of about 0 to 50 wt %.

28. The substrate according to claim 27, wherein the pigment or pigment dispersion or dye or combination thereof may be present in a range of about 0 to 30 wt %.

29. An article of manufacture comprising a nonwoven composite substrate, the article of manufacture comprising
(a) one surface having deposited thereon a water-based aliphatic urethane composition, optionally containing a carbodiimide crosslinker, the substrate and deposited composition having an oil crockfastness and a saline crockfastness in a range between about 2.8 to 5; and
(b) the nonwoven composite substrate.

30. The article of manufacture according to claim 29, wherein said article may house or contain materials selected from the group consisting of a food product, air, a landscaping product or debris, trash, garbage, items for purchase and a portion of an automobile or home appliance.

31. The article of manufacture according to claim 29, wherein said article of manufacture comprises one of a diaper, a hygiene product, a feminine care product, an article of clothing, a wipe, a filter, a shopping bag and a boat fabric or car interior fabric or felt.

32. The article of manufacture according to claim 29, wherein the substrate is comprised of polyolefin.

33. The article of manufacture according to claim 29, wherein the substrate is comprised of a polyamide.

34. The article of manufacture according to claim 29, wherein the substrate is comprised of a polyester.

35. The article of manufacture according to claim 29, wherein the substrate or composite thereof is comprised of a polylactic acid and its derivatives.

36. The article of manufacture according to claim 29, wherein the substrate is comprised of a copolymer.

37. The article of manufacture according to claim 29, wherein the substrate is comprised of a polyvinylchloride.

38. The article of manufacture according to claim 29, wherein said composition is deposited by a printing method comprising one of flexographic printing, rotogravure printing, inkjet printing, digital printing, screen printing and off-set printing or combination thereof.

39. The article of manufacture according to claim 38, wherein said printing method comprises a 4-color printing process.

40. The article of manufacture according to claim 38, wherein said printing method includes one of spraying, hopper or curtain coating, roller coating and blade coating.

41. The article of manufacture according to claim 29, wherein said composition comprises an aliphatic polyurethane.

42. The article of manufacture according to claim 29, wherein said composition comprises one of a polyester, a polycarbonate and a polyether.

43. The article of manufacture according to claim 42, wherein said composition comprises one of an emulsion, a solution and a dispersion.

44. The article of manufacture according to claim 43, wherein said composition comprises a polyester polyurethane dispersion.

45. The article of manufacture according to claim 29, wherein said composition further comprises an organic solvent.

46. The article of manufacture according to claim 45, wherein the organic solvent is selected from a group consisting of alcohols, glycols and glycol ethers.

47. The article of manufacture according to claim 45, wherein the organic solvent is present in the range of about 0 to 10 wt %.

48. The article of manufacture according to claim 47, wherein the organic solvent is present in the range of about 2 to 8 wt %.

49. The article of manufacture according to claim 29, wherein said carbodiimide crosslinker is a multifunctional carbodiimide crosslinker.

50. The article of manufacture according to claim 49, wherein the crosslinker may be present in a range of about 1 to 30 wt % of a total fluid composition.

51. The article of manufacture according to claim 50, the substrate and deposited composition having a dry crockfastness, an oil crockfastness and a saline crockfastness in a range between about 3.0 to 5.

52. The article of manufacture according to claim 29, wherein the composition further comprises one of a pigment, a pigment dispersion or a dye or combination thereof.

53. The article of manufacture according to claim 52, wherein the pigment dispersion is in the form of an epoxy based dispersion.

54. The article of manufacture according to claim 53, wherein the epoxy based dispersion is present in a concentration or ratio of about 2:1, pigment dispersion to resin.

55. The article of manufacture according to claim 52, wherein the pigment, pigment dispersion or dye or combination thereof is present in a range of about 0 to 99.99 wt %.

56. The article of manufacture according to claim 55, wherein the pigment, pigment dispersion or dye or combination thereof is present in the range of about 0 to 50 wt %.

57. The article of manufacture according to claim 56, wherein the pigment, pigment dispersion or dye or combination thereof is present in the range of about 0 to 30 wt %.

58. A polymeric film comprising one surface having deposited thereon a water-based aliphatic urethane composition containing a carbodiimide crosslinker, the film and deposited composition having an oil crockfastness and a saline crockfastness in a range between about 3.0 to 5.

59. The polymeric film according to claim 58, wherein said polymeric film comprises polyolefin.

60. The polymeric film according to claim 58, wherein said polymeric film comprises polyethylene.

61. The polymeric film according to claim 58, wherein said film and deposited composition have a dry crockfastness in a range between about 3.0 to 5.

62. A method of manufacturing an article comprising depositing thereon a water-based aliphatic urethane composition, optionally containing a carbodiimide crosslinker, the article of manufacture and deposited composition having an oil crockfastness and a saline crockfastness in a range between about 2.8 to 5.

63. The method according to claim 62, the composition containing the carbodiimide crosslinker, the article of manufacture and deposited composition having an oil crockfastness and a saline crockfastness in a range between about 3.0 to 5.

64. The method according to claim 62, the composition containing the carbodiimide crosslinker, the article of manufacture and deposited composition further having a dry crockfastness in a range between about 3.0 to 5.

65. The method according to claim 62, the article of manufacture and deposited composition further having a dry crockfastness in a range between about 3.0 to 5.
